(19) United States
(12) Patent Application Publication
(10) Pub. No.: US 2024/0380863 A1
(43) Pub. Date: Nov. 14, 2024

(54) Automatic Answering for Video Calls on Television

(71) Applicants: Costin Tuculescu, Tustin, CA (US); Gerald Norton, Hoboken, NJ (US)

(72) Inventors: Costin Tuculescu, Tustin, CA (US); Gerald Norton, Hoboken, NJ (US)

(21) Appl. No.: 18/658,875

(22) Filed: May 8, 2024

Related U.S. Application Data
(60) Provisional application No. 63/464,846, filed on May 8, 2023.

(51) Int. Cl. H04N 7/14

(52) U.S. Cl. CPC H04N 7/142; H04N 7/147

(57) ABSTRACT

The Automatic Answering for Video Calls on Television invention provides a user-friendly system for automatically answering incoming video calls on televisions, specifically designed for older adults, disabled individuals, and others with limited technical capabilities. The system ensures privacy by allowing only connected family members and friends to call the user. Upon answering the call, the system can turn on the television, switch inputs, and return to the previous input once the call has ended. This invention simplifies the video call experience and promotes accessibility using existing household technology.

### CROSS-REFERENCE TO RELATED APPLICATIONS

This application claims the benefit of U.S. Provisional Patent Application No. 63/464,846, filed on May 8, 2023, which is hereby incorporated by reference in its entirety.

### PRIOR ART

U.S. Pat. No. 8,994,881 B2
Title: Method and Apparatus for Simultaneously Viewing Multimedia Content and Accepting an Incoming Video Call Communication
Inventors: Fang-Yuan Shyu
Publication Date: Mar. 31, 2015
Description: This patent discloses a method and apparatus for enabling users to simultaneously view multimedia content and accept incoming video calls on a television. The system leverages Picture-in-Picture (PIP) technology to manage and display both multimedia content and video call data on the same screen. It incorporates functionality for the television to automatically wake up from standby mode when an incoming call signal is detected, displaying the call information alongside or over the ongoing content using PIP. Users can interact with the system via a remote control, which allows them to accept or reject incoming calls. The television system is designed to integrate with broadband networks for both audio and visual communication, enhancing its utility for real-time communication.
Relevance: This patent describes integrating video calling with multimedia content viewing using network communication and PIP technology on televisions. While it offers a method for accepting video calls using a remote control, it does not provide automated answering capabilities for seniors or users that have technology challenges, nor specify the use of HDMI CEC standards for controlling TV power and input settings, nor does it detail hardware configurations involving HDMI IN and OUT ports for automatic source switching.

U.S. Pat. No. 8,619,953 B2
Title: Home Videoconferencing System
Inventors: Paul G. Nietfeld, Krishna Sai, Edward W. Brakus, Jr., Edward Gonen, Shai Toren, Boris Rakhlin
Publication Date: Dec. 31, 2013
Description: This patent describes a home videoconferencing system that interfaces with traditional set-top boxes and typical home A/V equipment. The system includes a camera, a microphone, and a codec module. The codec module can connect directly to a modem connected to a television network and can interface between the set-top box and the display. It supports bidirectional communication, compresses and decompresses video and audio signals for videoconferencing, and can be implemented with various modifications for handling different audio-visual inputs and outputs.
Relevance: While this patent outlines a system that integrates videoconferencing with traditional home entertainment setups, it primarily focuses on interoperability with standard home components and doesn't specify any kind of automatic answering function, which would make the solution simpler and easier for older adults.

### FIELD OF THE INVENTION

The invention pertains to the field of telecommunications and more specifically to video call technology and television integration.

### BACKGROUND OF THE INVENTION

In recent years, video calling has become an essential means of communication, enabling people to connect visually and audibly from anywhere. Televisions, as a central component of most households, provide an ideal platform for video calling. However, current video calling systems integrated with televisions often require manual intervention using remote controls, mobile apps, mobile devices, or speech technology to answer incoming calls. This can be particularly challenging for older adults, disabled individuals, or those with limited technical capabilities, resulting in a barrier to staying connected with loved ones.

The Automatic Answering for Video Calls on Television invention aims to make video calling technology more accessible and usable for older adults and others who may have difficulty with conventional methods of answering video calls. By implementing an automated answering system, this invention allows individuals of any age or ability to stay connected without the need for manual intervention.

### SUMMARY OF THE INVENTION

The present invention relates to a system and method for facilitating video calls on a television, specifically designed to enhance accessibility and ease of use for individuals who may find traditional video calling interfaces challenging. The invention is particularly beneficial for older adults, disabled individuals, and those with limited technical skills.

The primary objective of this invention is to provide an automatic answering system for video calls that integrates seamlessly with television technology.

Key aspects of the invention include:

Automatic Activation: The system is capable of automatically answering incoming video calls without user intervention. This feature can be customized based on user preferences, which may include settings for specific callers, times of day, and days of the week.

User-Centric Customization: Users can set preferences for how calls are answered, including the option to have calls answered automatically or after a brief delay during which a visual and/or auditory alert may be presented. This allows users time to prepare for the incoming call if needed.

Hardware Integration: The invention includes a hardware component that connects to the television and the internet. This device controls the television's power state and input selection, ensuring that the television turns on and switches to the appropriate input when a call is incoming.

Privacy and Security: Calls can only be automatically answered from pre-approved contacts, ensuring that users' privacy is maintained. This system uses a cloud-based network to manage contact lists and settings, enhancing security by limiting access to authorized users only.

Seamless Transition Back: After a call has concluded, the system automatically returns the television to its previous state, whether that was turned off or set to a different input, reducing the need for manual handling and maintaining the natural usage patterns of the user.

The invention simplifies the process of receiving video calls on a television, making it more accessible and less intimidating for users who might otherwise be unable to take advantage of video calling technology. By automating the answering process and integrating deeply with television system controls, the invention ensures that users can effortlessly stay connected with their family and friends.

### BRIEF DESCRIPTION OF THE DRAWINGS

The accompanying drawings, which are incorporated herein and form a part of the specification, illustrate various exemplary embodiments of the present invention and together with the description further serve to explain various principles and to enable a person skilled in the pertinent art to make and use the invention.

FIG. 1 is an overview of the components of one exemplary embodiment of the invention.

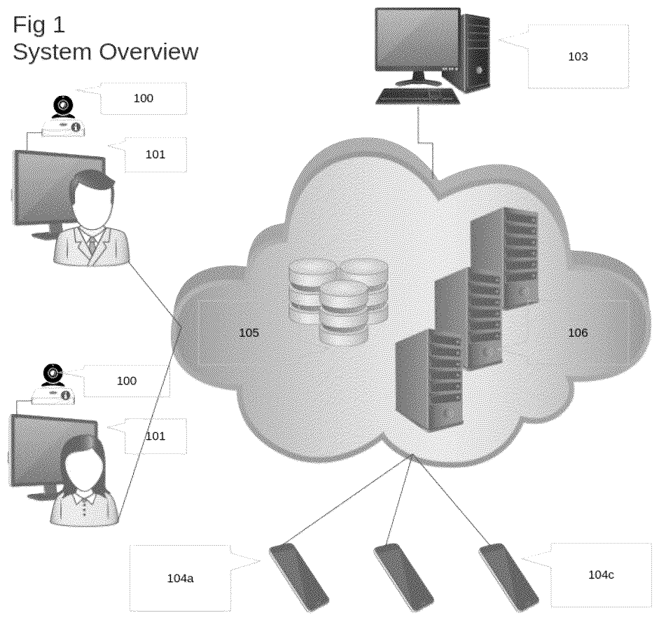

FIG. 2 is a block diagram illustrating the hardware component of one exemplary embodiment of the invention.

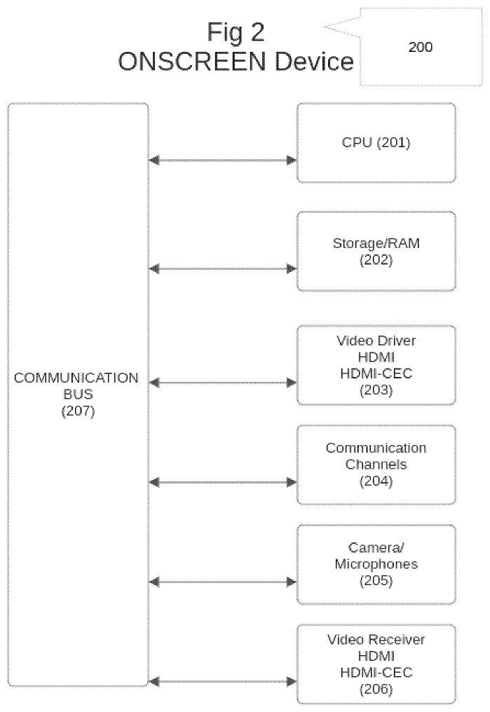

### DETAILED DESCRIPTION OF THE PREFERRED EMBODIMENT OF THE Invention

The invention pertains to a television-based video calling system designed to facilitate easier communication for users, particularly those who may have difficulty using traditional video calling technologies due to age, disability, or lack of technical familiarity. The system integrates a hardware device with a user's television and internet to manage incoming and outgoing video calls automatically based on user-defined settings.

### System Components

Hardware Device (100): Description: A compact, connectable module that links directly to the television via HDMI ports and to the internet via Wi-Fi or Ethernet. This device is equipped with a processor, memory, and software necessary for handling video call operations and television control functions.

HDMI Ports: Features HDMI IN and HDMI OUT ports. The HDMI IN port connects to external sources like cable boxes or streaming devices, while the HDMI OUT port connects to the television. This configuration allows the device to seamlessly switch between regular TV content and video calls.

Functionality: Manages the television's power state and input selection through HDMI CEC standard commands, ensuring that the television automatically turns on and switches to the appropriate input when a call is incoming. While HDMI CEC commands also serve as a backup for switching sources, the primary mechanism is through direct control via the HDMI ports.

Cloud-Based Management System (105): Description: A secure, cloud-based platform where users can manage their settings and contact lists (Favorites). This system stores information about authorized callers and user preferences regarding how calls should be answered.

Functionality: It processes incoming calls to determine if they should be automatically answered based on the caller's authorization status and user preferences.

### Operational Flow

Receiving a Call: When a call is incoming, the system first verifies the caller against the user's list of authorized contacts in the cloud-based management system.

If the caller is authorized, the hardware device activates, using HDMI CEC commands to power on the television if it is off and switch inputs to the HDMI port connected to the hardware device.

If the television is already on, or if the primary HDMI CEC input switch fails, the device will automatically switch the television's input from the HDMI IN source (e.g., cable box or streaming device) to the HDMI OUT source connected to the hardware device for the video call.

During the Call: The call is displayed on the television, utilizing the full screen for optimal visibility and interaction.

User interactions during the call (e.g., volume adjustments, ending the call) can be managed via a simple remote control interface designed for ease of use.

After the Call: Upon call termination, the system automatically switches the television back to the previous input source, whether it was a cable box, streaming device, or another HDMI source, using HDMI CEC commands or direct input toggling through the HDMI ports.

1. An automatic video call answering system for televisions, comprising:
a TV-based video calling device configured to control the television, including turning the television on and off and switching inputs to and from the video call automatically;
a cloud-based network of connected family and friends to establish privacy and authorization rules ensuring that only authorized individuals have their calls answered automatically;
cloud-based settings that specify television input ports for proper call handling; and
cloud-based settings to define time frames for enabling or disabling the auto-answer feature.

2. The system of claim 1, wherein the TV-based video calling device is further configured to display an incoming call notification with an adjustable duration.

3. The system of claim 1, wherein the cloud-based settings for enabling or disabling the auto-answer feature can be customized by the user.

4. The system of claim 1, wherein the television input ports specified in the cloud-based settings are user-configurable.

5. The system of claim 1, wherein the cloud-based network of connected family and friends is expandable, allowing the user to add or remove individuals as desired.

6. The system of claim 1, wherein the user has a means of declining the call.
